(19) United States
(12) Patent Application Publication
(10) Pub. No.: US 2026/0225828 A1
(43) Pub. Date: Aug. 6, 2026

(54) MOVER SYNCHRONIZATION SYSTEMS AND METHODS

(71) Applicant: ROCKWELL AUTOMATION TECHNOLOGIES, INC., Mayfield Heights, OH (US)

(72) Inventors: Brian M. Perreault, Stow, MA (US); David D. Brandt, New Berlin, WI (US); Haithem Mansouri, East Setauket, NY (US); Keith D. Carter, Locust, NC (US); Mark R. Cooper, Eden Prairie, MN (US); Paul Brooks, Everberg (BE); Steven T. Seidlitz, Eagle, WI (US); Yuhong Huang, Acton, MA (US)

(73) Assignee: ROCKWELL AUTOMATION TECHNOLOGIES, INC., Mayfield Heights, OH (US)

(21) Appl. No.: 19/044,100

(22) Filed: Feb. 3, 2025

(51) Int. Cl. B65G 47/53; B65G 43/08

(52) U.S. Cl. CPC B65G 47/53; B65G 43/08; B65G 2203/0225; B65G 2203/0283

(57) ABSTRACT

Systems, methods, and apparatuses of mover (or other track-based or autonomous mover component) synchronization are provided. A system may include a track-based mover. A system may include a non-track-based mover. A system may include one or more processors coupled with memory to: obtain a track coordinate of the track-based mover on a track, obtain a non-track coordinate of the non-track-based mover, provide a first control signal to cause the track-based mover to arrive at the track coordinate within a first time range, provide a second control signal to cause the non-track-based mover to arrive at the non-track coordinate within a second time range; and provide a third control signal to cause the transfer of a payload between the track based mover to the non-track based mover with the track-based mover located at the track coordinate and the non-track-based mover located at the non-track coordinate.

### BACKGROUND

Vehicles can deliver payloads or transfer items from one location to another.

### SUMMARY

At least one aspect is directed to a system. The system can include one or more processors, coupled with memory, a track-based mover, and a non-track-based mover. The one or more processors can be configured (e.g., via instructions or data stored in memory and accessed and executed by the one or more processors) to obtain a track coordinate of the track-based mover on a track. The one or more processors can be configured to obtain a non-track coordinate of the non-track-based mover. The one or more processors can be configured to provide a first control signal to cause the track-based mover to arrive at the track coordinate within a first time range. The one or more processors can be configured to provide a second control signal to cause the non-track-based mover to arrive at the non-track coordinate within a second time range. The one or more processors can be configured to provide a third control signal to cause the track-based mover to transfer a payload to the non-track-based mover with the track-based mover located at the track coordinate and the non-track-based mover located at the non-track coordinate.

At least one aspect is directed to a method. The method can include obtaining, by one or more processors coupled with memory, a track coordinate of a track-based mover on a track. The method can include obtaining a non-track coordinate of a non-track-based mover. The method can include providing a first control signal to cause the track-based mover to arrive at the track coordinate within a first time range. The method can include providing a second control signal to cause the non-track-based mover to arrive at the non-track coordinate within a second time range. The method can include providing a third control signal to cause the track-based mover to transfer a payload to the non-track-based mover with the track-based mover located at the track coordinate and the non-track-based mover located at the non-track coordinate.

At least one aspect is directed to a system. The system can include one or more processors, coupled with memory, a track-based mover, and a non-track-based mover. The one or more processors can be configured (e.g., via instructions or data stored in memory and accessed and executed by the one or more processors) to obtain a track coordinate of the track-based mover on a track. The one or more processors can be configured to obtain a non-track coordinate of the non-track-based mover. The one or more processors can be configured to provide a first control signal to cause the track-based mover to arrive at the track coordinate within a first time range. The one or more processors can be configured to provide a second control signal to cause the non-track-based mover to arrive at the non-track coordinate within a second time range. The one or more processors can be configured to provide a third control signal to cause the non-track-based mover to transfer a payload to the track-based mover with the track-based mover located at the track coordinate and the non-track-based mover located at the non-track coordinate.

At least one aspect is directed to a method. The method can include obtaining, by one or more processors coupled with memory, a track coordinate of a track-based mover on a track. The method can include obtaining a non-track coordinate of a non-track-based mover. The method can include providing a first control signal to cause the track-based mover to arrive at the track coordinate within a first time range. The method can include providing a second control signal to cause the non-track-based mover to arrive at the non-track coordinate within a second time range. The method can include providing a third control signal to cause the non-track-based mover to transfer a payload to the track-based mover with the track-based mover located at the track coordinate and the non-track-based mover located at the non-track coordinate.

This summary is illustrative and not intended to be limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The accompanying drawings are not intended to be drawn to scale. Like reference numbers and designations in the various drawings indicate like elements. For purposes of clarity, not every component can be labeled in every drawing. In the drawings:

FIG. 1 depicts an example system of mover synchronization.

FIG. 2 depicts an example system of mover synchronization.

FIG. 3 depicts an example system of mover synchronization.

FIG. 4 depicts an example system of mover synchronization.

FIG. 5 depicts an example method of mover synchronization.

FIG. 6 depicts an example schematic block diagram of a computing system.

### DETAILED DESCRIPTION

Following below are more detailed descriptions of various concepts related to, and implementations of, methods, apparatuses, and systems of mover synchronization. The various concepts introduced above and discussed in greater detail below may be implemented in any of numerous ways.

A track as described herein can be setup in a manufacturing or transportation or other facility where different types of movers work on different types of platforms and systems. These movers (e.g., vehicles, robots, or mobile units) can travel on different mediums such as tracks and warehouse spaces. These movers can interact with other movers of the same type. However, there may be times when a mover of one type can interact with a mover of a different type for various reasons.

Movers can travel along the track to deliver loads of goods, materials, and other items. Movers can move around an open space autonomously. The movers can carry payloads of various weights and move at different speeds. It can be a technical challenge for autonomous or other movers to interact with track-based movers due, for example, to a lack of synchronization, interconnectivity, or different mediums which the movers travel on. Therefore, if an autonomous or non-track-based mover determines or is instructed to interact with one or more track-based mover, other track-based movers may need to stand still or otherwise interrupt a routine in order to interact with the autonomous based mover. This can lead to inefficiencies as a system or movers can experience an interruption for a track-based mover to interact with an autonomous (or non-track-based) based mover, for example.

To overcome these and other challenges, the technical solutions of the present disclosure implement advanced features such as obtaining track coordinates of track-based movers and non-track coordinates of non-track-based movers. By providing control signals to cause a track-based mover to arrive at the track coordinate within a time range and cause a non-track-based mover to arrive at the non-track coordinate within a time range, the system can coordinate a transfer between the track-based mover and the non-based mover. By facilitating this transfer, the system reduces idle time, improves coordination between track and non-track activities, optimizes production schedules, minimizes bottlenecks, and enhances overall throughput and productivity.

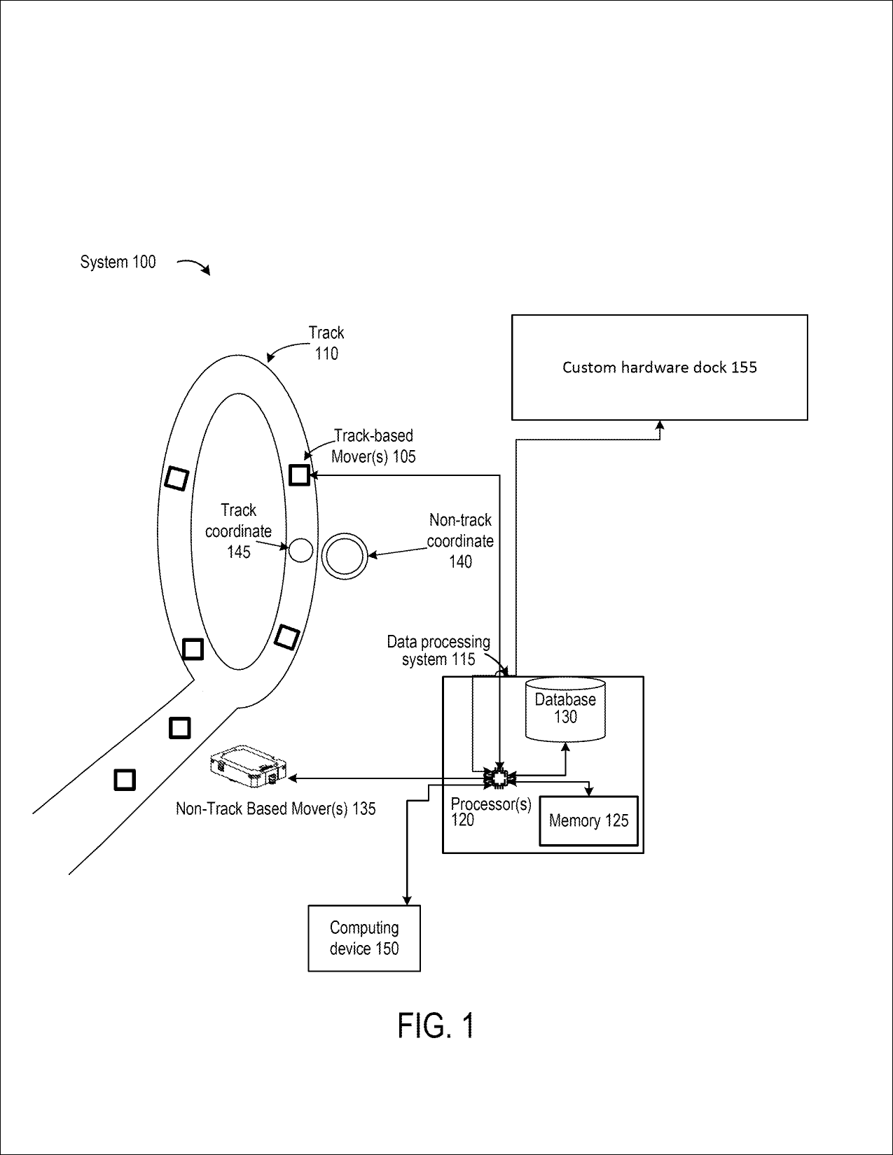

FIG. 1 depicts an example system 100 of mover synchronization. For example, the system 100 can include an independent cart or an autonomous mobile robot technology that can move at least one track-based mover 105 around at least one track 110 and move at least one non-track-based mover 135.

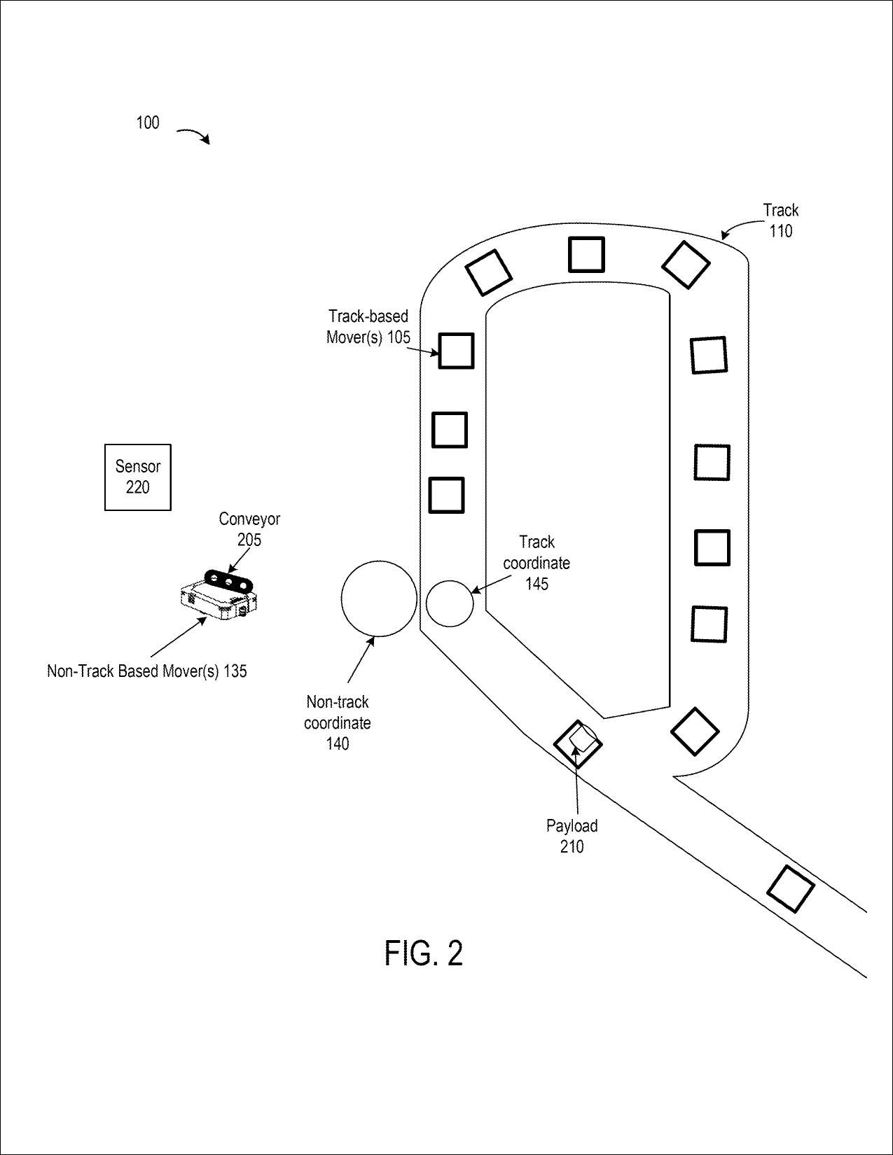

The system 100 can include at least one data processing system 115. The data processing system 115 can include one or more processors 120 coupled with memory 125. Processor 120 can include any combination of hardware and software for processing instructions, such as instructions for providing functionalities of the data processing system 115 or data, such as the data of sensor 220 (e.g., of FIG. 2 among others), track 110, mover 105, database 130, memory 125 or computing device 150. For example, the processor 120 can receive input data or instructions from a computing device 150. The processors 120 can be located in a programmable logic controller (PLC) or a high-level controller (HLC). The processor 120 can be or include a PLC or an HLC. The processors 120 can include mobile Processors, server Processors, embedded Processors (such as microcontrollers), multi-core Processors (including both single-core and multi-core variants), high-performance Processors, ARM Processors, x86 Processors, quantum Processors, FPGA-based Processors, graphics processing units (GPUs), digital signal processors (DSPs), artificial intelligence (AI) processors (such as neural processing units (NPUs) and tensor processing units (TPUs)), superscalar Processors, 64-bit Processors, hyper-threaded Processors, system-on-chip (SoC) Processors. The processor 120 may be located within a warehouse on a centralized controller or on a computing device 150 (i.e., mobile device, laptop, server, PC, etc.).

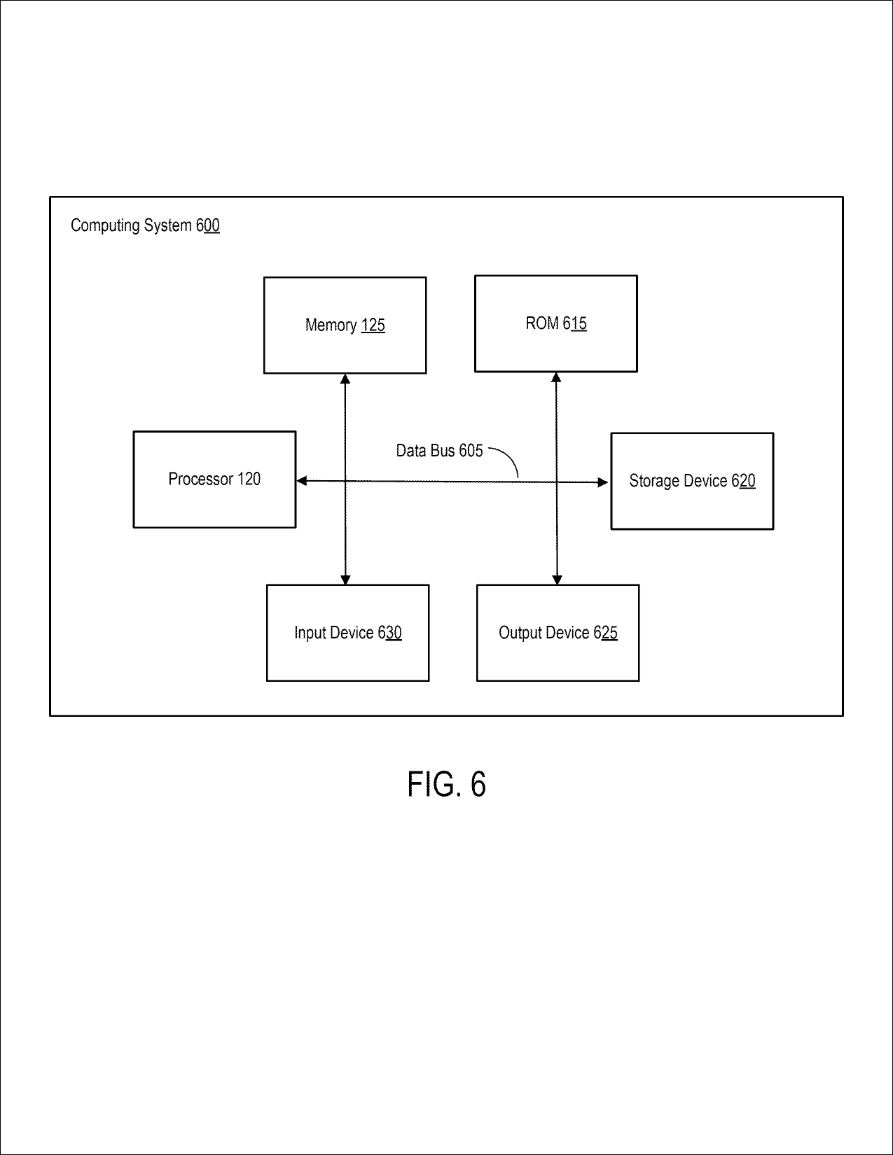

The data processing system 115 can include one or more processor(s) 120 coupled with memory 125. The memory 125 can include RAM or ROM. The data processing system 115 can be located in a programmable logic controller (PLC), a high-level controller (HLC), a track-based mover 105’s controller, or a non-track-based mover 135’s controller. The processors 120 can provide memory to storage device 620 (e.g., of FIG. 6 among others) or retrieve memory storage to determine the location of the track-based mover 105. For example, the data processing system 115 can be remote, distributed, or on-site. The data processing system 115 be entirely in the track-based mover 105, or the non-track-based mover 135. The data processing system 115 can be partially in the track-based mover 105, the non-track-based mover 135, or not in the either the track-based mover 105 or non-track-based mover 135.

The system 100 can include at least one track 110. The track 110 can include any combination of hardware and software for facilitating the movement, guidance, or alignment of payloads or vehicles. The track 110 can include one or more track-based movers 105. For example, the track 110 can include a conveyance system, a pathway dedicated for a mover 105, a structure consisting of a pair of parallel lines of rails, or a dedicated pathway. The track 110 can include raised walls, barriers along the edge of the pathway, or intersections with other parts of a track 110. The track 110 can include a central runner to guide the mover along the track, a smooth surface, rails, magnetic rails, or a magnetic surface. The track 110 can include a switch. The track 110 can include a segment of the track 110 designed to move vertically. The track 110 can include a rail-based track.

The system 100 can include at least one database 130. Database 130 can include any combination of hardware and software for storing data or information. The database 130 can include or utilize, for example, a storage device, such as, storage device 620 of FIG. 6. The database 130 can include, for example, various data structures for storing and relating various types and form of data utilized by the system 100. The database 130 can include and store, for example, data from the data processing system 115, data on track-based movers 105, data on track 110, data on non-track-based mover 135, as well as data from sensors 220. The database 130 can be part of the memory 125 or separate from the memory 125.

The system 100 can output to display by a computing device 150. For example, the computing device 150 can include or utilize, for example, an output device, such as, output device 625 of FIG. 6. Computing device 150 can include a computing device, a monitor, a server, a mobile device, a television, a Human-Machine Interface (HMI) panel.

Illustrated is at least one track-based mover 105. Track-based mover 105 can include any combination of hardware and software for transporting, guiding, or positioning payloads along a designated track. For example, the track-based mover 105 can include an independent cart technology (ICT)-based mover, conveyor-based mover, automated guided vehicles (AGV), autonomous mobile robots, linear motor movers, automated guided vehicles (AGV) using linear synchronous motor (LSM) technology, or independent cart technology (ICT)-based mover using linear synchronous motor (LSM) technology. The track-based mover 105 can include gliding or rolling contact with track 110. The track-based mover 105 can travel around a track 110. The track-based mover 105 can independently move around the track 110. The track-based mover 105 can move bidirectionally or unidirectionally around the track 110. The track-based movers 105 can communicate with other track-based movers 105. Multiple track-based movers 105 can be present and in motion on the track 110 concurrently, travelling to and from the same or different origins or destinations. The track-based mover 105 can be programmed to be autonomous. The track-based movers 105 can include motors. The track-based mover 105 can include a hall effect sensor. The track-based mover 105 can magnetically glide across the track 110. The track-based movers 105 can roll across the track 110. The track-based mover 105 can have a unique id assigned to it. The data processing system 115 can trace the unique ID of the track-based mover 105. The track-based mover 105 can include a Near Field Communication chip, a Bluetooth chip, a Bluetooth low energy chip, a radio frequency identification (RFID) chip, a Wi-fi chip, or a cellular chip. The data processing system 115 can use a camera to identify and track the track-based mover 105. The data processing system 115 can measure the magnetic signature of the track-based mover 105 to identify and trace the track-based mover 105. The track-based mover 105 can interact with the non-track-based mover 135. The track-based mover 105 can include a first local data processing system that can receive a first control signal and then generate a local control signal to navigate the track-based mover 105 to a position of the track 110 corresponding to the track coordinate 145. The system 100 can include a plurality of track-based movers 105. The track-based mover 105 can include a mechanical engagement system such as a pin and socket in order to verify the track-based mover 105 is aligned with another mover or machine when a transfer occurs. The track-based mover’s 105 thrust can be disabled. The track-based mover 105 can transfer a payload 210 (e.g., of FIG. 2 among others) to the non-track-based mover 135.

The system 100 can include at least one non-track-based mover 135. Non-track-based mover 135 can include any combination of hardware and software for transporting, maneuvering, or positioning payloads. The non-track-based mover 135 can include an independent moving vehicle, automated guided vehicles (AGV), autonomous mobile robots (AMR), linear motor movers, or an automated guided vehicles (AGV) using linear synchronous motor (LSM) technology. The non-track-based mover 135 can communicate with track-based movers 105. The non-track-based mover 135 communicate with other non-track-based movers 135. The non-track-based mover 135 can interact with a track-based mover 105 while maintaining a minimum speed. For example, the non-track-based mover 135 can pick up a payload 210 (e.g. of FIG. 2, among others) while moving at the same speed of the other non-track-based movers 135 in the area. The minimum speed can be a preset speed or the speed of other non-track-based movers 135 in the vicinity. The non-track-based mover 135 can interact using a robotic arm or a conveyor 205 (e.g., of FIG. 2 among others). Multiple non-track-based movers 135 can interact with other non-track-based movers 135. Non-track-based movers 135 can interact with track-based movers 105. The non-track-based mover 135 can include a conveyor 205 (e.g., of FIG. 2, among others). The non-track-based mover 135 can include a robotic arm. The non-track-based mover 135 can synchronize with the track-based mover 105. The non-track-based mover 135 can follow a mission between a start point and a non-track coordinate 140 where the non-track-based mover can switch to a synchronized state between the start point and the non-track coordinate 140, where the non-track-based mover is synchronized with the track-based mover 105 and adjust its speed to arrive at the non-track coordinate 140 at the same time that the track-based mover 105 arrives at a track coordinate 145. The movers will enter the synchronized state when the track-based mover 105 or the non-track-based mover 135 are at the start point, enroute to a destination or when track-based mover 105 or the non-track-based mover 135 are instructed to transfer a payload 210 (e.g., of FIG. 2 among others). The track-based mover 105 or the non-track-based mover 135 can synchronize wirelessly or through a wired connection. The system 100 can synchronize the track-based mover 105 or the non-track-based mover 135 with another mover (e.g., a track-based mover 105 or a non-track-based mover 135). The track-based mover 105 or the non-track-based mover 135 can synchronize with a track-based mover 105 or a non-track-based mover 135. The non-track-based mover 135 can be autonomous. The system 100 can include a plurality of non-track-based movers 135. The non-track-based mover 135 can include a pin or socket that can engage with the track-based mover 105 in order to verify the non-track-based mover and the track-based mover are engaged with each other. The non-track-based mover 135 can include a mechanical engagement system such as a pin and socket in order to verify the non-track-based mover 135 is aligned with another mover or machine when a transfer occurs. The non-track-based mover 135 can be autonomous or remote controlled. This precise synchronization requires constant communication and real-time data exchange between the track-based mover 105 and the non-track-based mover 135, facilitated by the data processing system 115.

The synchronized state can include a condition where the track-based mover 105 and the non-track-based mover 135 are in perfect alignment, allowing for seamless transfer of payloads. The synchronization process involves several key components, such as sensors 220 to monitor position and velocity, processors 120 to compute and issue commands, and communication modules to maintain a steady exchange of data. The system 100 (e.g. data processing system 115 components such as the processor(s) 120) can obtain at least one non-track coordinate 140 of the non-track-based mover 135. For example, the system 100 can obtain the non-track coordinate 140 directly from the processor 120, from memory 125, or from database 130. The non-track coordinate 140 can represent a position of track 110. The non-track coordinate 140 can represent a position adjacent to a track 110. The non-track coordinate 140 can represent a position adjacent to the track coordinate 145. The non-track coordinate can be the same as the track coordinate 145. The track coordinate 145 can be a bar code, a quick-response (QR) code, information representing a quick-response (QR) code, information representing a bar code, a near field communication sensor, data representing a location on the track 110, a Bluetooth chip, and a laser on the track 110. For example, the non-track coordinate 140 can identify a point in an area. The non-track coordinate 140 can include a threshold distance for a non-track-based mover 135 indicating the non-track mover is located at or within a range of the non-track coordinate 140. The non-track coordinate 140 can be considered to include an area with a surface around the non-track coordinate that can be considered to include a square, a rectangle, an oblong shape, a triangle, a diamond, a circle, or an irregular shape. The non-track coordinate 140 can identify a point. The non-track coordinate 140 can be a point in an irregular range. The non-track coordinate 140 can be a representation of an area. The non-track coordinate 140 can include an area with the coordinate located at point inside the boundaries of the area. The non-track coordinate 140 can be or include a transfer zone that has the non-track coordinate 140 located in it. The transfer zone can represent a point, location, range, or area where a non-track-based mover 135 can transfer a payload 210 (e.g., of FIG. 2, among others).

The system 100 (e.g. data processing system 115 components such as the processor(s) 120) can obtain at least one track coordinate 145 of the track-based mover 105 on the track 110. For example, the system 100 can obtain the track coordinate 145 directly from the processor 120, from the memory 125, or from the database 130. The track coordinate 145 can represent a position of track 110. The track coordinate 145 can represent a location on track 110. The track coordinate 145 can be a bar code, a quick-response (QR) code, information representing a quick-response (QR) code, information representing a bar code, a near field communication sensor, data representing a location on the track 110, a Bluetooth chip, and a laser on the track 110. The track coordinate 145 can include a threshold distance for a track-based mover 105 indicating the track-based mover 105 is located at the track coordinate 145. The track coordinate 145 can be considered to include an area with a surface around the track-coordinate that can be considered to include a square, a rectangle, an oblong shape, a triangle, a diamond, a circle, or an irregular shape. The track coordinate 145 can identify a point. The point can be circular and have a radius between 1 nanometer to 1 meter. The track coordinate 145 can be a representation of an area. For example, the track coordinate 1145 can be considered to include a shape with the coordinate located at point inside the boundaries of the shape.

The system 100 (e.g. data processing system 115 components such as the processor(s) 120) can provide at least one or more first control signals to cause the track-based mover 105 to arrive at the track coordinate 145 within a first time range. For example, the system 100 can provide the first control signal wirelessly or through a wired connection to the track 110 or the track-based mover 105. The system 100 can provide the first control signal using Wi-Fi, Bluetooth, near field communication, radio, Infrared, Zigbee, cellular, Long range, Radio frequency identification, and Ultra-wideband signals. The first control signal can include the second control signal or the third control signal. The first control signal can be encrypted. The first control signal can be digitally signed. The track-based mover 105 can arrive at the track coordinate 145 when the track-based mover 105 enters the transfer zone. The track-based mover 105 can arrive at the track coordinate 145 when the track-based mover 105 enters the area marked by the track coordinate 145. The first time range can include a time period between 1 second and 10 seconds. The first time range can be seconds, minutes, milliseconds or some arbitrary time. The first time range can be based on a standardized time. The first time range can include a time range that is calculated by the track-based mover 105 or the non-track-based mover 135. The first time range can include a time range that is calculated by a processor 120 or the data processing system 115. The first time range can be based on the position of the track-based mover 105 relative to the track coordinate 145, the position of the non-track-based mover 135 relative to the non-track coordinate 140, or both. The first time range can be changed dynamically.

The system 100 can provide a second control signal to cause the non-track-based mover 135 to arrive at the non-track coordinate 140 within a second time range. For example, the system 100 can provide the second control signal wirelessly or through a wired connection to the track 110 or the non-track-based mover 135. For example, the system 100 can provide the second control signal using Wi-Fi, Bluetooth, near field communication, radio, Infrared, Zigbee, cellular, Long Range, Radio frequency identification, and Ultra-wideband signals. The second control signal can include the first control signal or the third control signal. The non-track-based mover 135 can arrive at the non-track coordinate 140 when the non-track-based mover 135 enters the transfer zone. The non-track-based mover 135 can arrive at the non-track coordinate 140 when the non-track-based mover 135 enters the area marked by the non-track coordinate 140. The second control signal can be encrypted. The second control signal can be digitally signed. For example, the second time range can include a time period between 1 second and 10 seconds, among other ranges both greater than or less than this range. The second time range can include a time range that is calculated by the track-based mover 105 or the non-track-based mover 135. The second time range can include a time range that is calculated by a processor 120. The second time range can be based on the position of the track-based mover 105 relative to the track coordinate 145 or the position of the non-track-based mover 135 relative to the non-track coordinate 140. The second time range can be changed dynamically. The second time range can be the same as the first time range or different from the first time range.

The system 100 can provide one or more third control signal to cause the track-based mover 105 to transfer one or more payload(s) 210 (e.g., of FIG. 2 among others) to the non- track-based mover 135 with the track-based mover 105 located at the track coordinate 145 and the non-track-based mover 135 located at the non-track coordinate 140. For example, the system 100 can provide the third control signal wirelessly or through a wired connection to the track 110 or the non-track-based mover 135. The system 100 can provide the third control signal using Wi-Fi, Bluetooth, near field communication, radio, Infrared, Zigbee, cellular, Long Range, Radio frequency identification, and Ultra-wideband signals. The third control signal can be encrypted or unencrypted. The third control signal can be digitally signed. The third control signal can include the first control signal, the second control signal, or neither the first nor the second control signal. The track-based mover 105 can transfer the payload 210 (e.g., of FIG. 2 among others) using momentum. The track-based mover 105 can transfer the payload 210 using a conveyor 205 (e.g., of FIG. 2 among others) located next to the track coordinate 145. The conveyor 205 (e.g., of FIG. 2 among others) can be located on the track coordinate 145.The third control signal can cause the non-track-based mover 135 to transfer the payload 210 (e.g., of FIG. 2 among others) to the track-based mover 105 with the track-based mover 105 located at the track coordinate 145 and the non-track-based mover 135 located at the non-track coordinate 140.

The data processing system 115 can map a track coordinate 145 with a non-track coordinate 140 to a position based on the 3D map of the area provided to the data processing system 115.

The data processing system 115 can translate data from a track-based mover 105 into data that is readable by a non-track-based mover 135. The data processing system 115 can enable coordination between a track-based mover 105 and a non-track-based mover 135.

FIGS. 2-4 depict an example of system 100 of mover synchronization. The system 100 can include at least one conveyor 205. Conveyor 205 can include any combination of hardware and software for accepting, transporting, maneuvering, or positioning objects such as payload 210. For example, the conveyor 205 can be coupled to the non-track-based mover 135 or the track 110. The conveyor 205 can include a robotic arm, a conveyor belt, a vacuum device, a suction mechanism, a roller mechanism, a pin and slot mechanism, a mechanical claw, a magnet, a pusher, and a diverter. The conveyor 205 can be a structure to transfer a payload 210 from point a to point b. The conveyor 205 can include the ability to weigh objects, scan QR codes, and scan bar codes. The conveyor 205 can include a magnetic feature, be fully magnetic, or a rolling mechanism. The conveyor 205 can communicate with track-based mover 105, the non-track-based mover 135, the sensor 220, or the track 110. One or more conveyors 205 can be attached to the non-track-based mover 135. One or more conveyors 205 can be attached to the track 110. For example, the conveyor 205 can be manually controlled or autonomously controlled. The conveyor 205 can be mounted on the non-track-based mover 135. The conveyor 205 can facilitate the transfer of the payload 210 from the track-based mover 105 to the non-track-based mover 135. The conveyor 205 can be attached to the track 110. The conveyor 205 can be controlled by a processor 120. The conveyor can be separate from the track-based mover 105 or the non-track-based mover 135.

The system 100 can include at least one payload 210. The payload 210 can include objects such as vaccines, products, medical equipment, industrial equipment, consumer products, and agricultural products. The payload 210 can include pharmaceuticals, perishable goods, industrial components, consumer electronics, hazardous materials, documents and packages, automotive parts, construction materials, textiles and apparel, and agricultural products. For example, the payload 210 can include objects intended to be conveyed from a point A to a point B. The payload 210 can include objects intended to be moved by movers such as the track-based mover 105 and the non-track-based mover 135. The payload 210 can be transferred from the non-track-based mover 135 to the track-based mover 105 using a conveyor 205 (e.g., a robotic arm) that is attached to the non-track-based mover 135. The payload 210 can include the part of the cargo carried on the track-based mover or non-track-based mover producing revenue.

The system 100 can include at least one sensor 220. Sensor 220 can include any combination of hardware and software for sensing or measuring data used by the example system 100. For example, sensor 220 can include devices, systems, components, or circuits for capturing or measuring signals indicative of presence, state, velocity, or any other characteristics of movers of various types such a track-based mover 105 and a non-track-based mover 135. Sensor 220 can include any combination of sensors or detector for capturing various analog or digital data. For example, sensor 220 can include radar sensors for measuring mover speed and distance, and lidar sensors for creating 3D maps of track 110 or detecting shapes and distances of various entities. Sensor 220 can include ultrasonic sensors configured for detection of movers at various distances from the sensors 220. Sensor 220 can include infrared sensors to detect thermal signatures of track-based mover 105 on track 110. The sensor 220 can include doppler radar sensors to measure entity speeds, or piezoelectric sensors to detect weight and speed. The sensor 220 can include optical or fiber optic sensors for monitoring movement, velocity, or direction, as well as stress and strain on track surfaces. The sensor 220 can include laser rangefinders to measure track 110 distances and mover 105 positions. The sensor 220 can include vibration sensors to detect mover 105 movement on track 110, as well as accelerometers to measure the acceleration, deceleration, speed, and orientation of movers 105. The sensor 220 can include water detection sensors to detect presence of water. The sensor 220 can include gas sensors to detect gases (e.g., oxygen, carbon dioxide, methane). The sensor 220 can include barometric pressure sensors to measure atmospheric pressure. The sensor 220 can include a weight sensor, a laser sensor, a camera, or a LiDAR camera. The sensor 220 can include a Near Field Communication sensor, a barcode scanner, a quick response (QR) code scanner, a Bluetooth chip, a Bluetooth sensor, a Bluetooth low energy sensor, a radio frequency identification (RFID) sensor, a Wi-fi sensor, or a cellular sensor to track the mover 105. Sensor 220 can include Hall effect sensors to detect magnetic fields. Sensor 220 can be located in the track-based mover 105 and in the non-track-based mover 135. The sensor 220 can be located in a programmable logic controller (PLC), a high-level controller (HLC) or a mover 105’s controller. The sensor 220 can be located on track 110.

The system 100 (e.g. data processing system 115 components such as the processor(s) 120) can determine the presence of a payload 210 (e.g. of FIG. 2 among others). For example, the system 100 can determine the presence of payload 210 using data received from one or more sensor 220. The system 100 can determine the presence of the payload 210 using object recognition techniques or image processing techniques. The system 100 can determine the presence of payload in conjunction with one or more sensor(s) 220. The system 100 can determine the presence of the payload 210 using a sensor 220. The sensor 220 can provide the system 100 data such as weight data, laser data, image data, location data, arrival data, or detection data to indicate the presence of the payload 210. The sensor 220 can be located at the track coordinate 145 or the non-track coordinate 140. The system 100 can determine the presence of a payload 210 by analyzing the weight of the payload 210, the signal being emitted from the payload 210, or scanning a code or mark on the payload 210.

The system 100 (e.g. data processing system 115 components such as the processor(s) 120) can confirm location of the track-based mover 105 at the track coordinate 145 within the first time range. For example, the system 100 can confirm the location of the track-based mover 105 using data received from one or more sensors 220. The data received from one or more sensors 220 can be location data, detection data (i.e. object detection data), image data (i.e. image recognition data), weight data, scanner data, and signal data (i.e., Wi-Fi, Bluetooth, radio, cellular, NFC, RFID). The location of the track-based mover 105 can be represented by the track-based mover’s 105 physical location. The system 100 can confirm the location of the track-based mover 105 by scanning a QR code, or a barcode located on the track-based mover when the track-based mover is located at the track coordinate 145. The system 100 can scan different types of codes using the sensor 220. The system 100 can confirm the location of the track-based mover 105 by analyzing a signal emitting from the track-based mover 105 and validating the signal emitting from the track-based mover 105 is indicating the track-based mover 105 is located at the track coordinate 145. The system 100 can scan and analyze different signals using sensor 220. The signal emitting from the track-based mover 105 can include a near field communication signal, a Bluetooth signal, a Wi-Fi signal, a radio signal, a cellular signal, or an ultra-wide signal. The system 100 can confirm location of the track-based mover 105 at the track coordinate 145 using image recognition or object detection techniques. The system 100 can confirm location of the track-based mover 105 at the track coordinate 145 within the first time range by analyzing the time the track-based mover 105 arrived at the track coordinate 145.

The system 100 (e.g. data processing system 115 components such as the processor(s) 120) can confirm location of the non-track-based mover 135 at the non-track coordinate 140 within the second time range. For example, the system 100 can confirm the location of the non-track-based mover 135 using data received from one or more sensors 220. The data received from one or more sensors 220 can be location data, detection data (i.e. object detection data), image data (i.e. image recognition data), weight data, scanner data, and signal data (i.e., Wi-Fi, Bluetooth, radio, cellular, NFC, RFID). The location of the non-track-based mover 135 can be represented by the non-track-based mover’s 135 physical location. The system 100 can confirm the location of the non-track-based mover 135 by scanning a QR code, or a barcode located on the track-based mover when the track-based mover is located at the track coordinate 145. The system 100 can scan different types of codes using the sensor 220. The system 100 can confirm the location of the non-track-based mover 135 by analyzing a signal emitting from the non-track-based mover 135 and validating the signal emitting from the non-track-based mover 135 is indicating the non-track-based mover 135 is located at the non-track coordinate 140. The system 100 can scan and analyze different signals using sensor 220. The signal emitting from the track-based mover 105 can include a near field communication signal, a Bluetooth signal, a Wi-Fi signal, a radio signal, a cellular signal, or an ultra-wide signal. The system 100 can confirm location of the track-based mover 105 at the track coordinate 145 using image recognition or object detection techniques. The system 100 can confirm location of the track-based mover 105 at the track coordinate 145 within the first time range by analyzing the time the track-based mover 105 arrived at the track coordinate 145.

The system 100 (e.g. data processing system 115 components such as the processor(s) 120) can determine one or more orientations of the one or more non-track-based movers 135. For example, the system 100 can determine that the orientation is the correct orientation. The orientation can be a correct orientation for the non-track-based mover 135 to face in order to receive the payload 210. The non-track-based mover 135 can change its orientation dynamically based on the position of the payload 210 or the track-based mover 105. The correct orientation can be based off a predetermined orientation.

The system 100 (e.g. data processing system 115 components such as the processor(s) 120) can provide one or more third control signals, based on the one or more orientations of the non-track-based movers 135. For example, the third control signal can be provided wirelessly or through a wired connection with the track 110.The system 100 can provide the third control signal via Wi-Fi, Bluetooth, radio signal, RFID, NFC, or satellite signal. The third control signal can be provided with the first time range or the second time range. The third control signal can be provided in the same manner as the first control signal or second control signal. The third control signal can be provided when the orientation of the non-track-based mover 135 faces the payload 210 in such a way that the non-track-based mover can accept or retrieve the payload 210 from the track-based mover 105.

The system 100 (e.g. one or more sensors 220) can detect the non-track-based mover 135, the track-based mover 105, and the payload 210. For example, the system 100 can include any type and form of a system for detecting objects such as objects in a warehouse, objects on a track, and objects located on movers. The sensors 220 can include one or more cameras, including image cameras, to capture images of objects such as the non-track-based mover 135, the track-based mover 105, and the payload 210. The sensors 220 can include a camera with object detection software or image recognition software to detect the objects such as movers, payloads (i.e., payload 210), and other objects in a warehouse. Sensors 220 can include Light Detection and Ranging (LiDAR) enhanced cameras to detect various movers and various payloads and their distances as well as motion detection cameras to detect which objects are in motion. The sensors 220 can include object AI-enhanced cameras to detect and classify objects.

The system 100 (e.g. one or more sensors 220) can compare a parameter of the payload with a threshold parameter to determine that the payload satisfies the threshold parameter. For example, the parameter of the payload 210 can indicate that the threshold parameter can be 15 lbs. The parameter of the payload 210 can indicate that the threshold parameter meets a predetermined criteria of the object shape and weight. The parameter of the payload can indicate that the threshold parameter is a certain object with a distinct shape. The parameter of the payload can be a QR code, the information contained in the QR code, a bar code, the information contained in the bar code, a scannable image, or an NFC chip.

The system 100 (e.g. data processing system 115 components such as the processor(s) 120) can cause conveyor 205 to transfer the payload 210 from the non-track-based mover 135 to the track-based mover 105 with the track-based mover 105 located at the position of the track 110 corresponding to the track coordinate 145 and the non-track-based mover 135 located at the position corresponding to the non-track coordinate 140. For example, the conveyor 205 can transfer the payload 210 by push, pulling, dragging, suctioning, or magnetizing the payload 210. The conveyor 205 can be a robotic arm and transfer the payload 210 from the track-based mover 105 or the non-track-based mover 135 to the track-based mover 105 or the non-track-based mover 135. The conveyor 205 can be a conveyor belt and transfer the payload 210 while the track-based mover 105 or the non-track-based mover 135 is maintaining a minimum velocity. The minimum velocity can include or be velocities of zero miles an hour, five miles an hour, ten kilometers an hour, or ranges of velocities such as between zero kilometers an hour to 40 kilometers an hour. The system 100 (e.g. data processing system 115 components such as the processor(s) 120) can cause conveyor 205 to transfer the payload 210 from the track-based mover 135 to the non-track-based mover 105 with the track-based mover 105 located at the position of the track 110 corresponding to the track coordinate 145 and the non-track-based mover 135 located at the position corresponding to the non-track coordinate 140.

The system 100 (e.g. data processing system 115 components such as the processor(s) 120 can include track-based movers 105 used as part of modifying the payload in a manufacturing process. For example, Raw materials can be fed from the non-track-based mover 135 to the track-based mover 105. Raw materials can be fed from the non-track-based mover 135 to the track-based mover 105 using a conveyor 205. The conveyor 205 can be located on the track 110, attached to the track-based mover 105, attached to the non-track-based mover 135, standalone next to the track 110, or be attached to the track 110. Finished goods, products, or payload 210 can be transferred from the track-based mover 105 to the non-track-based mover 135. Finished goods, products, or payloads 210 can be transferred from the non-track-based mover 135 to the track-based mover 105. Finished goods, products, or payloads 210 can be transferred using a conveyor 205.

The system 100 (e.g. data processing system 115 components such as the processor(s) 120) can include an Automated Storage and Retrieval System (ASRS). The track 110 can be used to implement the ASRS. The track 110 can be the ASRS. The track-based mover 105 can be used to implement an ASRS. The non-track-based mover 135 can be used to retrieve and store payloads, raw materials, or finished goods from the ASRS. The non-track-based mover 135 can convey the payloads, raw materials, or finished goods to or from hand-off points in a manufacturing system, a shipping and receiving system or a shipping and receiving dock. The non-track-based mover can use the conveyor 205 to retrieve, store or convey payloads, raw materials, or finished goods from the ASRS.

The system 100 (e.g. data processing system 115 components such as the processor(s) 120 can include a custom hardware dock 155. For example, the custom hardware dock 155 can include a dock where non-track-based movers 135 deliver or pickup payloads 210 and track-based movers 105 can go and pickup or deliver payloads 210. The track 110 can be or include the custom hardware dock 155. The custom hardware dock 155 can include or be the track 110. The custom hardware dock 155 can be located near the track 110. The custom hardware dock 155 can include slots to enable transfers of payloads, materials or goods between track-based movers 105 and non-track-based movers 135.

The system 100 (e.g. data processing system 115 components such as the processor(s) 120) can provide a control signal to cause a segment of the track 110 located at the position of the track 110 corresponding to the track coordinate 145 to move from a first position to second position to deposit the payload 210 on to the non-track-based mover 135 with the track-based mover 105 located at a position of the track 110 corresponding to the track coordinate 145. The segment of the track 110 can be rail based, conveyor based, magnetic gliding based, or independent cart technology based. The segment of the track 110 located at the position of the track 110 corresponding to the track coordinate 145 can be moved vertically, horizontally, and laterally. The segment of the track 110 located at the position of the track 110 corresponding to the track coordinate 145 can tilt, shift, oscillate, or rotate. The first position and the second position of the segment of track 110 can be located at various positions on the track 110.

The system (e.g. data processing system 115 components such as the processor(s) 120) can provide the first control signal to cause the track-based mover 105 to follow a first path to arrive at a track coordinate 145 within a first time range. For example, the first path can include the shortest path to arrive at the track coordinate 145, the longest path to arrive at the track coordinate 145, the most efficient path to arrive to the track coordinate 145, the least efficient path to the track coordinate 145, the path of the track 110, or the path that causes the track-based mover 105 to arrive at the track coordinate 145 at the same time as the non-track-based mover 135 arrives at the non-track coordinate 140. The first control signal can include instructions to cause the track-based mover 105 to slow down speed up, separate from other track-based movers 105, or take a shortcut path if available on the track 110. The system 100 can adjust the first path dynamically. The track-based mover 105 can adjust the first path dynamically. The first path can include a section along track 110, a path that is not on the track 110, or a combination of a path on the track 110 and a path off the track 110. The first control signal can include instructions for the track-based mover 105 to follow the first path.

The system 100 (e.g. data processing system 115 components such as the processor(s) 120) can provide the second control signal to cause the non-track-based mover 135 to follow a second path to arrive at a non-track coordinate within a second time range. For example, the second path can include the shortest path to arrive at the non-track coordinate 140, the fastest path to arrive at the non-track coordinate 140, the most efficient path to arrive at the non-track coordinate 140, a standardized path to arrive at the non-track coordinate 140, or the most direct path to arrive at the non-track coordinate 140. The system 100 can dynamically adjust the second path. The non-track-based mover 135 can adjust the second path dynamically. The second control signal can include instructions to cause the non-track-based mover 135 to follow the second path.

The system 100 can include a track-based mover 105 which can include a first local data processing system to receive the first control signal and to generate a local control signal to navigate the track-based mover 105 to a position of the track 110 corresponding to the track coordinate 145. For example, the first local data processing system can be data processing system 115 or part of data processing system 115. The first local data processing system can be located in the track-based mover 105, outside the track-based mover 105, or on the track 110. The first local data processing system can send signals wirelessly or through a wired connection to the track-based mover 105. The first local data processing system can receive signals from the data processing system 115, or the computing device 150. The first local data processing system can enable the track-based mover 105 to be autonomous or act autonomously. The local control signal can be sent wirelessly or through a wired connection to the track-based mover 105. The local control signal can be encrypted. The local control signal can include the first, second, or third control signal. The local control signal can cause the track-based mover 105 to synchronize with the non-track-based mover 135

The system 100 can include a non-track-based mover 135 which can include a second local data processing system to receive the second control signal and to generate a local control signal to navigate the track based mover to a position corresponding to the non-track coordinate. For example, the second local data processing system can be the data processing system 115 or part of the data processing system 115. The second local data processing system can include processors 120. The second local data processing system can be located in the non-track-based mover 135, outside the non-track-based mover 135, or on the track 110. The second local data processing system can send signals wirelessly or through a wired connection to the non-track-based mover 135. The second local data processing system can receive signals from the data processing system 115, or the computing device 150. The second local data processing system can enable the non-track-based mover 135 to act autonomously. The local control signal generated to navigate the non-track-based mover 135 can be sent wirelessly or through a wired connection to the non-track-based mover 135. The local control signal generated to navigate the non-track-based mover 135 can be encrypted. The local control signal can include the first, second, or third control signal. The local control signal can cause the non-track-based mover 135 to synchronize with the track-based mover 105.

The system 100 wherein the track-based mover 105 is a first track-based mover 105 can include a plurality of track-based movers 105 including the first track-based mover 105. The system 100 (e.g. data processing system 115 components such as the processor(s) 120) can provide a control signal to orient the plurality of track-based movers in a convoy formation. For example, a convoy formation can mean that if there are a first track-based mover 105 and a second track-based mover 105 in convoy formation, the back end of the first track-based mover 105 is within a threshold distance of the second track-based mover 105. The convoy formation can mean that track-based movers are within a threshold distance of each other while moving around the track 110. The convoy formation can mean that the first track-based mover 105 can maintain a different threshold distance from the remaining track-based movers 105.

The system 100 (e.g. data processing system 115 components such as the processor(s) 120), wherein the track-based mover 105 is a first track-based mover 105, can provide a control signal to orient the first track-based mover and the second track-based mover 105 such that the back end of the first track based mover is within a threshold distance of the front of the second track-based mover. For example, the control signal can orient the first track-based mover 105 in a synchronized manner with the second track-based mover 105. The threshold distance between the first track-based mover 105 and the second track-based mover 105 can include distances of two centimeters, one foot, two meters, or five inches. The threshold distance between the first track-based mover 105 and the second track-based mover 105 can include a distance of two feet between the back end of the first track-based mover 105 and the front end of the second track-based mover 105. The control signal to orient the first track-based mover 105 and the second track-based mover 105 can be provided wirelessly or through a wired connection to the movers. The control signal to orient the first track-based mover 105 and the second track-based mover 105 can cause the movers to orient in a convoy formation. The track-based mover 105 can be a first track-based mover of a plurality of track-based movers 105. The system 100 (e.g. data processing system 115 components such as the processor(s) 120) can provide a control signal to cause the first track-based mover to adjust its velocity. For example, the control signal can include the first, second, or third control signal. The control signal can include instructions to cause the track-based mover 105 to adjust its velocity. The track-based mover 105 including the first track-based mover 105 can adjust its velocity by applying brakes, disengaging thrust, disengaging its engine, applying more thrust, disengaging its brakes, or disengaging both thrust and brakes.

The system 100 (e.g. data processing system 115 components such as the processor(s) 120) can provide the third control signal to cause the non-track-based mover 135 to transfer the payload 210 to the track-based mover 105 with the track-based mover 105 maintaining a threshold velocity during a time period of the transfer and the non-track-based mover 135 located at a position corresponding to the non-track coordinate 140. The system 100 can provide third control signal to cause the track-based mover 105 to transfer the payload 210 to the non-track-based mover 135 with the track-based mover 105 maintaining a threshold velocity during a time period of the transfer and the non-track-based mover 135 located at a position corresponding to the non-track coordinate 140. The transfer of the payload between the track-based mover 105 and the non-track-based mover 135 can occur when the track-based mover 105 is located at the track coordinate 145, the track-based mover 105 is maintaining a threshold velocity, or the non-track-based mover 135 is located at the non-track coordinate 140. For example, the threshold velocity can be the same velocity as the other track-based movers 105 on the track 110. The non-track-based mover 135 can maintain the threshold velocity when transferring the payload 210 to the track-based mover 105. The track-based mover 105 and the non-track-based mover 135 can both maintain the threshold velocity while either the track-based mover 105 transfers the payload 210 to the non-track-based mover 135 or the non-track-based mover 135 transfers the payload 210 to the track-based mover 105. The threshold velocity can include a speed of 4 meters per second. The threshold velocity can be measured in meters, kilometers, miles, or feet. The threshold velocity can be a different velocity than the other track-based movers 105 on the track 110. The threshold velocity can be the same velocity as the non-track-based mover 135. The time period of the transfer can be the same length of time as the first time range, or the second time range. The time period of the transfer can be different from the first time range or the second time range. The time period of the transfer can be in milliseconds, seconds, or minutes. The time period of the transfer can be greater than the first and the second time range combined. The non-track-based mover 135 can maintain a threshold velocity of zero miles per hour while the track-based mover 105 maintains a threshold velocity above one mile per hour. The track-based mover 105 can maintain a different threshold velocity than the non-track-based mover 135. The non-track-based mover 135 can transfer payloads 210 to the track-based mover 105 while the track-based mover 105 is in motion.

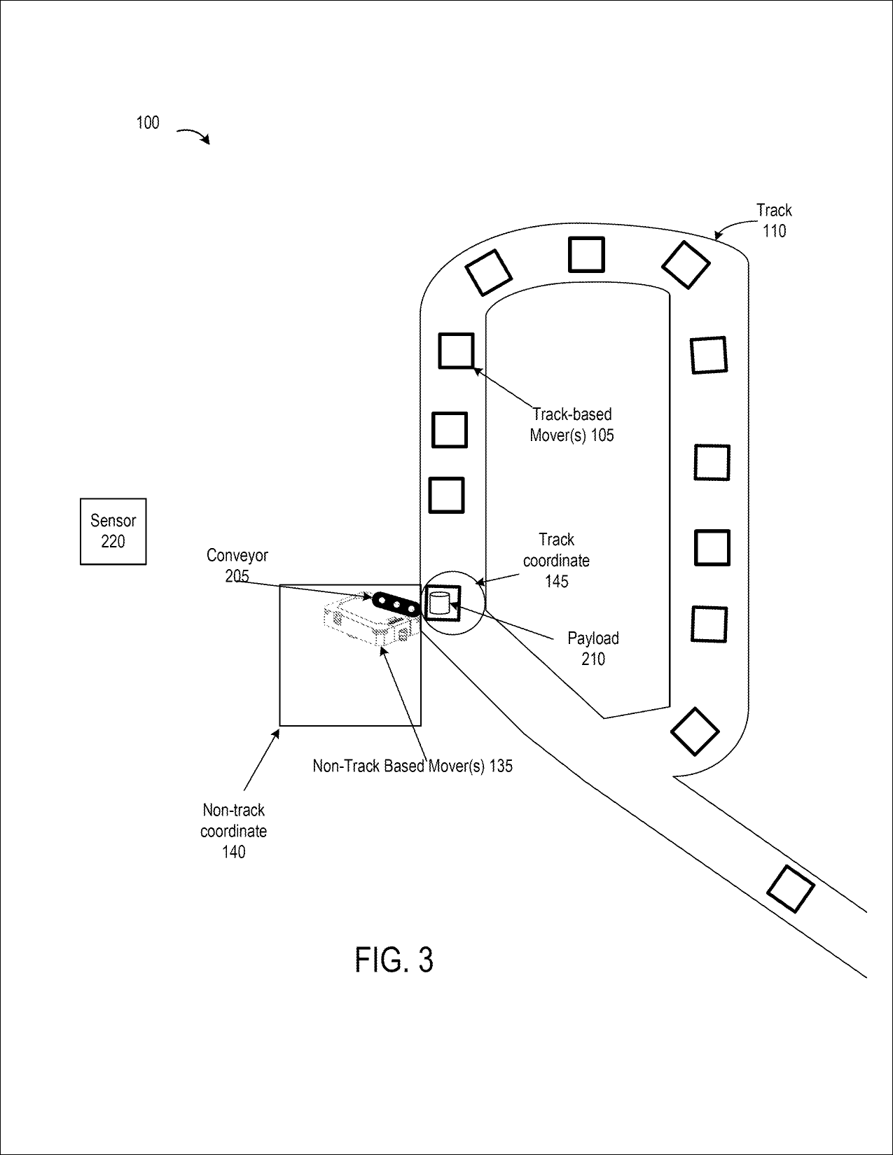

FIG. 3 depicts an example of system 100 of mover synchronization. For example, the non-track-based mover 135 can have at least one conveyor 205 mounted. The non-track-based mover 135 can use the conveyor 205 to transfer the payload 210 from the track-based mover 105 onto the non-track-based mover 135 when the track-based mover 105 is located at a position corresponding to the track coordinate 145 and the non-track-based mover 135 is located at a position corresponding to the non-track coordinate 140.

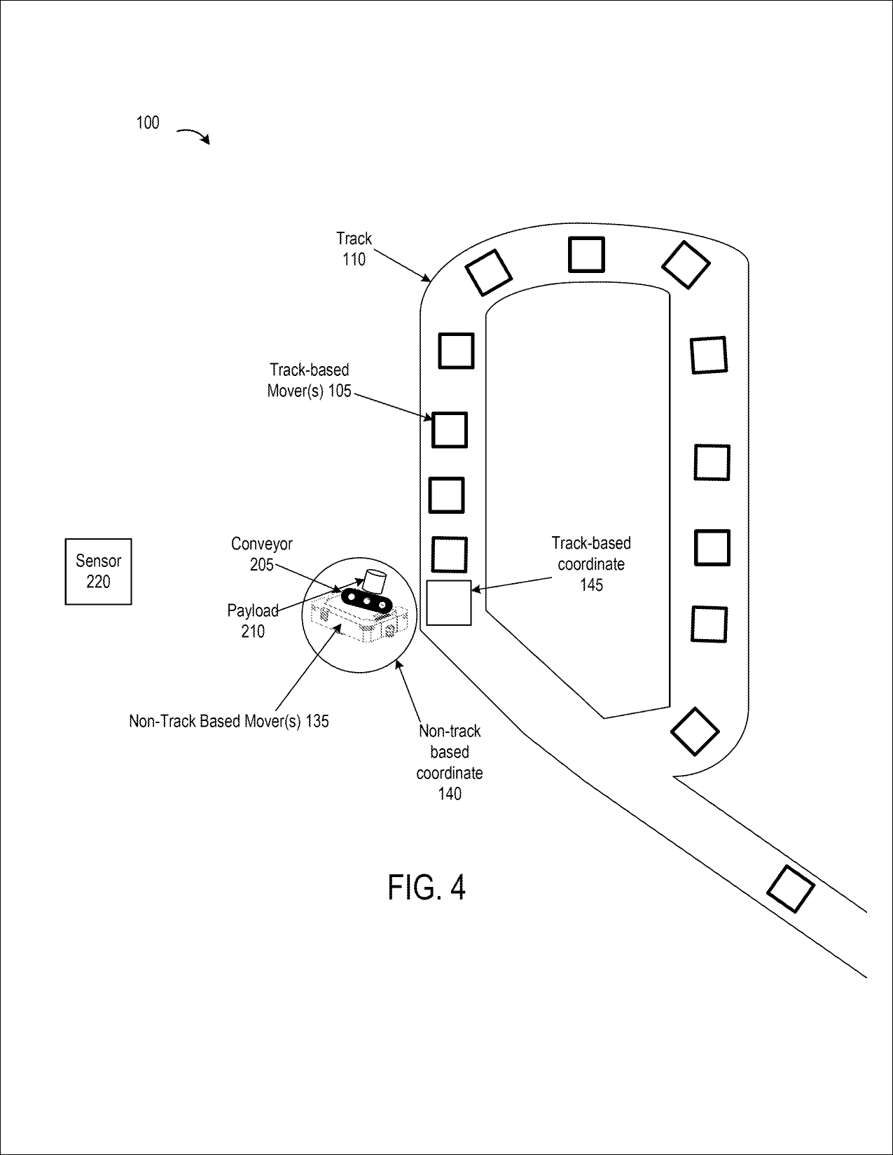

FIG. 4 depicts an example of system 100 of mover synchronization. For example, the non-track-based mover 135 mounted with a conveyor 205 can carry or transfer the payload 210 after the conveyor 205 transfers the payload 210 from the track-based mover 105. The track-based mover 105 can be located at the track coordinate 145 or not on the track coordinate 145.

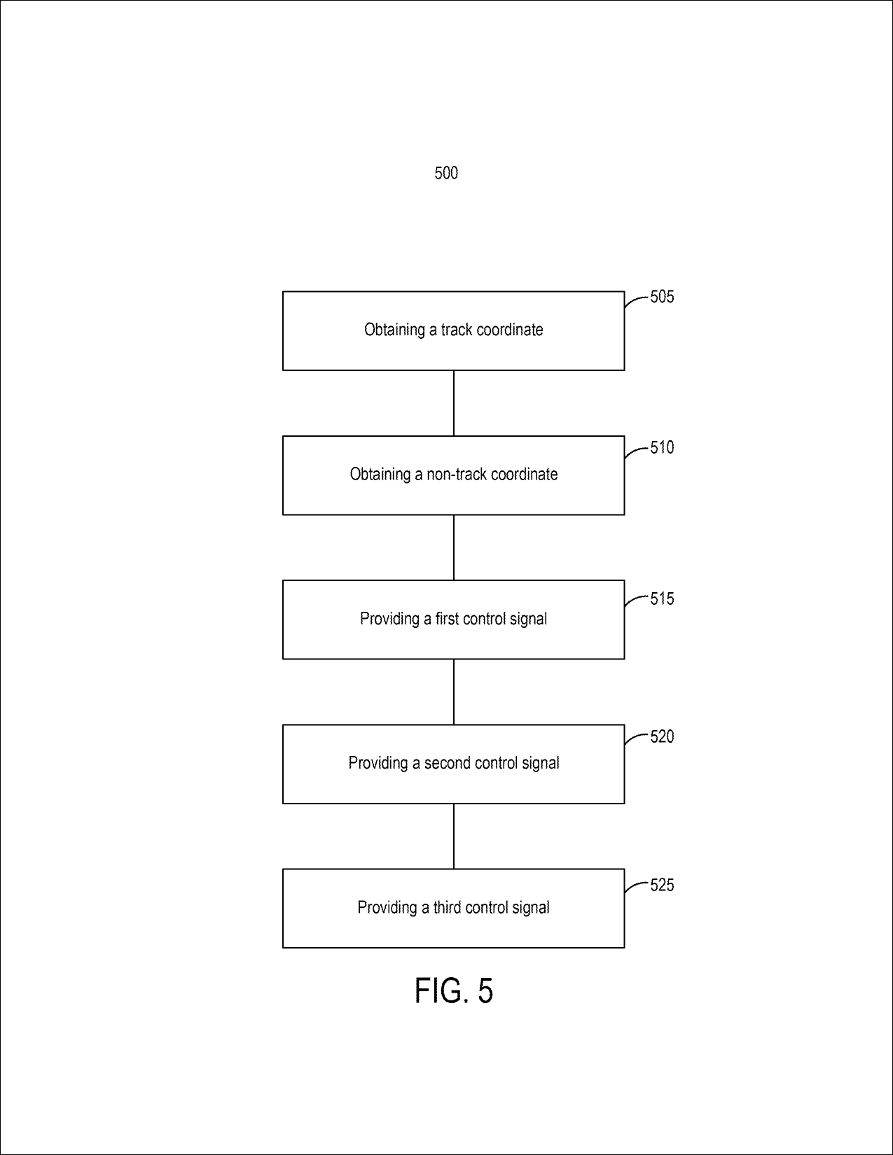

FIG. 5 depicts a method 500 of mover synchronization. The method 500 can include obtaining at least one track coordinate (ACT 505). For example, the track coordinate can be obtained from the input received from the computing device 150, from a local computer network, from a non-track-based mover, from an online network, from a local actor (e.g., an individual providing the track coordinate 145) or a local database (e.g., database 130). The system 100, the one or more processors 120, non-track-based mover, the data processing system 115, the track-based mover 105 can obtain the track coordinate. For example, the one or more processors can obtain a track coordinate of the track-based mover on a track.

The method 500 can include obtaining at least one non-track coordinate (ACT 510). For example, the one or more processors, the system, non-track-based mover, and data processing system can obtain the non-track coordinate. For example, the non-track-based coordinate can be obtained from the input received from the computing device, from a local computer network, from the non-track-based mover, from an online network, from a local actor (e.g., an individual providing the non-track coordinate), from one or more processors, or a local database. For example, the one or more processors can obtain a non-track-based coordinate of the non-track-based mover. The method 500 can obtain at least one non-track coordinate by retrieving or receiving the non-track coordinate from memory or the database. The non-track coordinate can be obtained from at least one input received.

The method 500 can include providing at least one first control signal (ACT 515). For example, the one or more processors, the system, the non-track-based mover, a third-party computer system, the computing device, or data processing system can provide the first control signal. The first control signal can be provided wirelessly, or through a wired connection. The first control signal can be provided by sending a signal to the data processing system. The first control signal can be provided from the data processing system, the computing device, a local actor, a third-party computing system, or the non-track-based mover. The first control signal can be retrieved from memory or the database. The first control signal can be provided to the track-based mover to cause the track-based mover to arrive at the track coordinate within a first time range. The first control signal can be provided to the track.

The method 500 can include providing at least one second control signal (ACT 525). For example, the one or more processors, the system, the track-based mover, a third party computer system, the computing device, or data processing system can provide the second control signal. The second control signal can be provided wirelessly, or through a wired connection. The second control signal can be provided by sending a signal to the data processing system. The second control signal can be provided from the data processing system, the computing device, a local actor, a third-party computing system, or the non-track-based mover. The second control signal can be retrieved from memory or the database. The second control signal can be provided to the non-track-based mover to cause the non-track-based mover to arrive at the non-track coordinate within a second time range.

The method 500 can include providing at least one third control signal (ACT 525). For example, the one or more processors, the system, the non-track-based mover, a third party computer system, the computing device, and data processing system can provide the third control signal. The third control signal can be provided wirelessly, or through a wired connection. The third control signal can be provided by sending a signal to the data processing system. The third control signal can be provided from the data processing system, the computing device, a local actor, a third-party computing system, or the non-track-based mover. The third control signal can be provided to the track-based mover, the non-track-based mover, or the track. The one or more processors can provide the third control signal to cause the track-based mover to transfer a payload to the non-track-based mover with the track-based mover located at the track coordinate and the non-track-based mover located at the non-track coordinate.

FIG. 6 illustrates a block diagram of an example computing system 600, also referred to as a computer system 600. The computing system 600 can include, included by, or be used to implement a data processing system 115. The computing system 600 includes at least one bus 605 or other communication component for communicating information and at least one processor 120 or processing circuit coupled to the bus 605 for processing information. The computing system 600 can also include one or more processors 120 or processing circuits coupled to the bus for processing information. The computing system 600 also includes at least one memory 125, such as a random-access memory (RAM) or other dynamic storage device, coupled to the bus 605 for storing information, and instructions to be executed by the processor 120. The memory 125 can be used for storing information during execution of instructions by the processor 120. The computing system 600 may further include at least one read only memory (ROM) 615 or other static storage device coupled to the bus 605 for storing static information and instructions for the processor 120. A storage device 620, such as a solid-state device, magnetic disk or optical disk, can be coupled to the bus 605 to persistently store information and instructions. The computing system 600 may be the computing device 150.

The computing system 600 may be coupled via the bus 605 to an output device 625, such as a liquid crystal display, or active-matrix display, for displaying information to a user. An input device 630, such as a keyboard or voice interface may be coupled to the bus 605 for communicating information and commands to the processor 120. The input device 630 can include a touch screen display. The input device 630 can also include a cursor control, such as a mouse, a trackball, or cursor direction keys, for communicating direction information and command selections to the processor 120 and for controlling cursor movement on the output device 625, such as a display.

The processes, systems and methods described herein can be implemented by the computing system 600 in response to the processor 120 executing an arrangement of instructions contained in memory 125. Such instructions can be read into memory 125 from another computer-readable medium, such as the storage device 620. Execution of the arrangement of instructions contained in memory 125 causes the computing system 600 to perform the illustrative processes described herein. One or more processors in a multi-processing arrangement may also be employed to execute the instructions contained in memory 125. Hard-wired circuitry can be used in place of or in combination with software instructions together with the systems and methods described herein. Systems and methods described herein are not limited to any specific combination of hardware circuitry and software.

While operations can be depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system of mover synchronization, comprising:
a track-based mover;
a non-track-based mover; and
one or more processors coupled with memory to:
obtain a track coordinate of the track-based mover on a track;
obtain a non-track coordinate of the non-track-based mover;
provide a first control signal to cause the track-based mover to arrive at the track coordinate within a first time range;
provide a second control signal to cause the non-track-based mover to arrive at the non-track coordinate within a second time range; and
provide a third control signal to cause the track-based mover to transfer a payload to the non-track-based mover with the track-based mover located at the track coordinate and the non-track-based mover located at the non-track coordinate.

2. The system of claim 1, comprising:
one or more processors coupled with memory to:
determine a presence of the payload;
confirm location of the track-based mover at the track coordinate within the first time range;
confirm location of the non-track-based mover at the non-track coordinate within the second time range;
determine an orientation of the non-track-based mover; and
provide the third control signal, based on the orientation of the non-track-based mover.

3. The system of claim 1, comprising one or more sensors to:
detect the non-track-based mover, the track-based mover, and the payload; and
compare a parameter of the payload with a threshold parameter to determine that the payload satisfies the threshold parameter.

4. The system of claim 1, comprising:
a conveyor;
the one or more processors coupled with memory to:
cause the conveyor to transfer the payload from the non-track-based mover to the track-based mover with the track-based mover located at the position of the track corresponding to the track coordinate and the non-track-based mover located at the position corresponding to the non-track coordinate.

5. The system of claim 1, comprising:
the track including a rail-based track; and
the one or more processors coupled with memory to provide a control signal to cause a segment of the track located at the position of the track corresponding to the track coordinate to move from a first position to a second position to deposit the payload on to the non-track-based mover with the track based mover located at a position of the track corresponding to the track coordinate.

6. The system of claim 1, comprising:
the one or more processors coupled with memory:
provide the first control signal to cause the track-based mover to follow a first path to arrive at a track coordinate within the first time range;
provide the second control signal to cause the non-track-based mover to follow a second path to arrive at a non-track coordinate within the second time range; and
provide the third control signal to cause the non-track-based mover to transfer a payload to the track-based mover with the track-based mover located at the track coordinate and the non-track-based mover located at the non-track coordinate.

7. The system of claim 1, comprising:
the track-based mover including a first local data processing system to receive the first control signal and to generate a local control signal to navigate the track-based mover to a position of the track corresponding to the track coordinate; and
the non-track-based mover including a second local data processing system to receive the second control signal and to generate a local control signal to navigate the track-based mover to a position corresponding to the non-track coordinate.

8. The system of claim 1, comprising:
a plurality of non-track-based movers; and
a plurality of track-based movers.

9. The system of claim 1, wherein the track-based mover is a first track-based mover, comprising:
a plurality of track-based movers including the first track-based mover; and
the one or more processors coupled with memory to provide a control signal to orient the plurality of track-based movers in a convoy formation.

10. The system of claim 1, comprising:
the one or more processors coupled with memory to:
provide the third control signal to cause the track-based mover to transfer the payload to the non-track-based mover with the track-based mover maintaining a threshold velocity during a time period of the transfer with the track-based mover located at the track coordinate and the non-track-based mover located at the non-track coordinate.

11. The system of claim 1, wherein the track-based mover is a first track-based mover, comprising:
a first track-based mover;
a second track-based mover; and
the one or more processors coupled with memory to provide a control signal to orient the first track-based mover and the second track-based mover such that the back end of the first track-based mover is within a threshold distance of the front of the second track-based mover.

12. The system of claim 1, wherein the track-based mover is a first track-based mover, comprising:
a plurality of track-based movers including the first track-based mover;
the one or more processors coupled to memory to provide a control signal to cause the first track-based mover to adjust its velocity.

13. The system of claim 1, comprising:
the one or more processors coupled to memory to provide the third control signal to cause the non-track-based mover to transfer the payload to the track-based mover with the track-based mover maintaining a threshold velocity during a time period of the transfer with the non-track-based mover located at a position corresponding to the non-track coordinate and the track-based mover located at a position corresponding to the track coordinate.

14. A method, comprising:
a track-based mover;
a non-track-based mover;
obtaining, by one or more processors coupled with memory, a track coordinate of the track-based mover on a track;
obtaining, by one or more processors, a non-track coordinate of the non-track-based mover;
providing, by one or more processors, a first control signal to cause the track-based mover to arrive at the track coordinate within a first time range;
providing, by one or more processors, a second control signal to cause the non-track-based mover to arrive at the non-track coordinate within the a second time range; and
providing, by one or more processors, a third control signal to cause the track-based mover to transfer a payload to the non-track-based mover with the track-based mover located at the track coordinate and the non-track-based mover located at the non-track coordinate.

15. The method of claim 14, comprising:
determining, by one or more processors, a presence of the payload;
confirming, by one or more processors, location of the track-based mover at the track coordinate within the first time range;
confirming, by one or more processors, location of the non-track-based mover at the non-tracking, by one or more processors, coordinate within the second time range;
determining, by one or more processors, an orientation of the non-track-based mover; and
providing, by one or more processors, the third control signal, based on the orientation of the non-track-based mover.

16. The method of claim 14, comprising:
detecting, by one or more processors, the non-track-based mover, the track-based mover, and the payload; and
comparing, by one or more processors, a parameter of the payload with a threshold parameter to determine that the payload satisfies the threshold parameter.

17. The method of claim 14, comprising:
a conveyor;
causing, by one or more processors, the conveyor to transfer the payload from the non-track-based mover to the track-based mover with the track-based mover located at the position of the track corresponding to the track coordinate and the non-track-based mover located at the position corresponding to the non-track coordinate.

18. The method of claim 14, comprising:
providing, by one or more processors, the first control signal to cause the track-based mover to follow a first path to arrive at a track coordinate within the first time range;
providing, by one or more processors, the second control signal to cause the non-track-based mover to follow a second path to arrive at a non-track coordinate within the second time range; and
providing, by one or more processors, the third control signal to cause the non-track-based mover to transfer a payload to the track-based mover with the track-based mover located at the track coordinate and the non-track-based mover located at the non-track coordinate.

19. The method of claim 14, comprising:
providing, by one or more processors, the third control signal to cause the non-track-based mover to transfer the payload to the track-based mover with the track-based mover maintaining a minimum threshold velocity during a time period of the transfer and with the track-based mover located at the track coordinate and the non-track-based mover located at the non-track coordinate.

20. A system of mover synchronization, comprising:
a track-based mover;
a non-track-based mover; and
one or more processors coupled with memory to:
obtain a track coordinate of the track-based mover on a track;
obtain a non-track coordinate of the non-track-based mover;
provide a first control signal to cause the track-based mover to arrive at the track coordinate within a first time range;
provide a second control signal to cause the non-track-based mover to arrive at the non-track coordinate within a second time range; and
provide a third control signal to cause the non-track-based mover to transfer a payload to the track-based mover with the track-based mover located at the track coordinate and the non-track-based mover located at the non-track coordinate.
